(19) United States
(12) Patent Application Publication
(10) Pub. No.: US 2014/0111108 A1
(43) Pub. Date: Apr. 24, 2014

(54) SYSTEM CONTROL UNIT, LED DRIVER INCLUDING THE SYSTEM CONTROL UNIT, AND METHOD OF CONTROLLING STATIC CURRENT OF THE LED DRIVER

(71) Applicant: SILICON WORKS CO., LTD., Daejeon-si (KR)

(72) Inventors: Wanyuan QU, Daejeon-si (LR); Ju Pyo HONG, Daejeon-si (KR); Ok Hwan KWON, Daejeon-si (KR); Chang Sik SHIN, Daejeon-si (KR); Kyung Min KIM, Gunsan-si (KR); Byeong Ho JEONG, Daejeon-si (KR); Yong Goo KIM, Daejeon-si (KR); Young Suk SON, Daejeon-si (KR)

(73) Assignee: SILICON WORKS CO., LTD., Daejeon-si (KR)

(21) Appl. No.: 14/029,553

(22) Filed: Sep. 17, 2013

Related U.S. Application Data
(60) Provisional application No. 61/703,640, filed on Sep. 20, 2012.

(51) Int. Cl. H05B 33/08

(52) U.S. Cl. CPC H05B 33/0815
USPC 315/206; 315/307

(57) ABSTRACT

Embodiments of the present invention provide a light-emitting diode (LED) driver and method of controlling the static current of the LED driver. In some embodiments, the LED driver is configured to calculate output currents of a pulse form using a small number of parameters and adjust a gate control signal using the mean value of the output currents of a pulse form. Accordingly, the LED driver can be used to control a static current that flows through an LED array connected to a circuit on the secondary side of a transformer using a DC voltage or an AC voltage supplied to the primary side of the transformer. In some embodiments, the LED driver includes a power conversion unit, switching unit, transformer, zero current detection unit, and system control unit. In some embodiments, the system control unit is configured to adjust the gate control signal.

### CROSS-REFERENCE TO RELATED APPLICATION

This non-provisional patent application claims priority to the provisional patent application having U.S. Ser. No. 61/703,640, filed on Sep. 20, 2012, the entire contents of which are incorporated by reference herein.

### BACKGROUND OF THE INVENTION

1. Field of the Invention

Embodiments of the present invention relate to a light-emitting diode (LED) driver and method of controlling static current for the LED driver. In some embodiments, the LED driver is configured to estimate current flowing through a diode connected to a secondary coil of a transformer using a point of time at which a power transistor connected to a primary coil of the transformer is turned off, a point of time at which the diode is turned off, a peak value of current that flows through the power transistor on the primary side of transformer, and a time interval in which current flows through the diode on the secondary side of the transformer. In some embodiments, the LED driver is also configured to adjust a gate control signal for controlling the operation of the power transistor using a mean value. In some embodiments, the LED driver is further configured to control static current supplied to the LED array using the gate control signal.

2. Description of the Related Art

LED lighting refers to a lighting apparatus configured to have static current flow through an LED and maintain constant luminosity. The luminosity of the LED can be adjusted by controlling the amount of static current that flows through the LED. If a mean current flowing through the LED is constant, it is said that the static current is controlled.

FIG. 1 is a circuit diagram of a conventional LED driver.

Referring to FIG. 1, the LED driver 100 includes a power conversion unit 110, a transformer 120, a switching unit 130, a system control unit 140, and a zero current detection unit 150 placed on the primary side of the transformer 120.

A full-wave rectifier 111 of the power conversion unit 110 rectifies an AC voltage V_{ac} supplied to the primary side, and a DC input voltage V_{IN} is generated using the rectified voltage through a first capacitor C1. The switching unit 130 includes a power transistor Q1 and a switching resistor Rₛ that are coupled in series. The power transistor Q1 operates in response to a gate control signal V_{G}. The transformer 120 transfers the DC input voltage V_{IN}, generated from the power conversion unit 110, to the secondary side of the transformer 120 according to a turn ratio of the primary winding N_{P} and the secondary winding N_{S} of a coil that forms the transformer 120 depending on the switching operation of the power transistor Q1 connected to a primary coil of the transformer 120. The zero current detection unit 150 generates a resonant voltage V_{W} into which a value obtained by multiplying the sum of voltage V_{F} that drops to a diode D1 connected to a secondary coil of the transformer 120 and voltage V_{O} that drops to an LED array 160 connected to the secondary side by a ratio of a secondary-side winding Nₛ and an auxiliary winding Nₐ is incorporated in a process in which energy stored on the primary side of the transformer 120 is transferred to the secondary side, in particular, in an interval in which the power transistor Q1 is turned off.

The system control unit 140 includes an output current (I_{O}) estimator 141, a diode turn-on (T_{D}) interval estimator 142, a voltage (Vo) estimator 143, and a pulse width modulation (PWM) controller 144. The I_{O} estimator 141 estimates a current I_{O} that flows through the LED array 160 using voltage CS corresponding to a current I_{ds} that flows through the power transistor Q1. The diode turn-on interval estimator 142 estimates a time interval T_{D} in which the diode D1 connected to the secondary coil is turned on using a division voltage V_{S} obtained by dividing the resonant voltage V_{W} at a specific ratio. The Vo estimator 143 estimates voltage V_{O} that drops to the LED array 160 using a time interval T_{D} in which the diode D1 connected to the secondary coil is turned on and a division voltage V_{S} obtained by dividing a feedback voltage V_{W} at a specific ratio. The PWM controller 144 generates the gate control signal V_{G} that determines the amount of static current supplied to the LED array 160 using the voltage V_{O} that drops to the LED array 160.

FIG. 2 shows waveforms at a specific node of the LED driver shown in FIG. 1.

Referring to FIG. 2, the current I_{ds} that flows through the power transistor Q1 increases in an interval T_{ON} in which the power transistor Q1 is turned on in one unit interval T_{S} and does not flow in an interval T_{S}-T_{ON} in which the power transistor Q1 is turned off.

The diode D1 connected to the secondary coil is turned on at the moment when the power transistor Q1 is turned off, and thus the current I_{D} flowing through the diode D1 has a peak value I_{D}_{_{—}}ₚ of a diode current, having an amount obtained by multiplying a peak value Iₚₖ of the current I_{ds} that flows through the power transistor Q1 by a turn ratio N_{P}/N_{S} of the number of turns of the primary coil N_{P} and the number of turns of the secondary coil N_{S} that form the transformer 120. The current I_{D} flowing through the diode D1 connected to the secondary coil slowly decreases from the peak value I_{D}_{_{—}}ₚ of the diode current at the early stage of the turn-on and becomes a zero state when a point of time at which the diode D1 connected to the secondary coil is turned off.

The resonant voltage V_{W} has a negative voltage level when the power transistor Q1 is turned on, but has a voltage level, that is, a value obtained by multiplying the sum of the voltage V_{F} that drops to the diode D1 connected to the secondary coil and the voltage V_{O} that drops to the LED array 160 connected to the secondary side by a ratio of the secondary winding Nₛ and the auxiliary winding Nₐ at the moment when the power transistor Q1 is turned off and then has a constant resonance characteristic a point of time at which the diode D1 connected to the secondary coil is turned off. Here, the resonance characteristic refers to LC resonance between a parasitic capacitor (not shown), formed between the drain and source terminals of the power transistor Q1 that is turned off, and an inductor that forms the transformer 120.

In the case of the LED driver shown in FIG. 1, in order to generate the gate control signal V_{G}, all the peak value Iₚₖ of the current I_{ds} that flows through the power transistor Q1, the turn ratio N_{P}/N_{S} of the primary winding N_{P} and the secondary winding N_{S} of the coil that forms the transformer 120, one cycle T_{S} of the gate control signal V_{G}, and the turn-on interval T_{D} of the diode D1 on the secondary side must be known. Furthermore, there is a disadvantage in that a computational load is great and a circuit becomes complicated in order to generate a new gate control signal V_{G} using the values.

### SUMMARY OF SELECTED EMBODIMENTS OF THE INVENTION

Accordingly, embodiments of the present invention have been made in an effort to solve the problems occurring in the related art, and an object of some of these embodiments is to provide a system control unit for calculating output currents of a pulse form using a small number of parameters and generating a gate control signal using the mean value of the output currents of a pulse form.

Another object is to provide an LED driver including the system control unit for calculating output currents of a pulse form using a small number of parameters and generating a gate control signal using the mean value of the output currents of a pulse form.

Yet another object is to provide a method of controlling the static current of the LED driver, which calculates output currents of a pulse form using a small number of parameters and generates a gate control signal using the mean value of the output currents of a pulse form.

In order to achieve one or more of these objects, embodiments of the present invention provide a system control unit included in an LED driver, where the LED driver also includes a switching unit, a transformer, and a zero current detection unit. In such embodiments, the switching unit includes a power transistor configured to operate in response to a gate control signal, and a switching resistor placed between the power transistor and a ground voltage. The transformer is configured to transfer an input voltage to a secondary coil of the transformer at a specific ratio in response to a switching operation of the switching unit connected to a primary coil of the transformer. The zero current detection unit is placed on the primary side of the transformer and is configured to generate a resonant voltage into which voltage that drops to an LED array connected to the secondary coil and voltage that drops to a diode connected to the secondary coil are incorporated. In addition, in such embodiments, the system control unit is configured to estimate a second peak value that is a highest value of currents flowing through the diode using current flowing through the power transistor. The system control unit is also configured to calculate a mean value of currents supplied to the LED array for a specific time interval using a point of time at which the power transistor is turned off, a point of time at which the diode is turned off, and the second peak value. The system control unit is further configured to update the gate control signal using the mean value. In addition, in some embodiments, the system control unit is configured to determine the point of time at which the power transistor is turned off by using the gate control signal.

Embodiments of the present invention also provide an LED driver having a power conversion unit, a switching unit, a transformer, a zero current detection unit, and a system control unit. In such embodiments, the power conversion unit is configured to generate an input voltage by rectifying a supply voltage of an AC form. The switching unit includes a power transistor configured to operate in response to a gate control signal, and a switching resistor placed between the power transistor and a ground voltage. The transformer is configured to transfer the input voltage or a supply voltage of a DC form to a secondary coil of the transformer at a specific ratio in response to a switching operation of the switching unit connected to a primary coil of the transformer. The zero current detection unit is placed on the primary side of the transformer and is configured to generate a resonant voltage into which voltage that drops to an LED array connected to the secondary coil and voltage that drops to a diode connected to the secondary coil are incorporated. The system control unit is configured to estimate a second peak value that is a highest value of currents flowing through the diode using current flowing through the power transistor. The system control unit is also configured to calculate a mean value of currents supplied to the LED array for a specific time interval using a point of time at which the power transistor is turned off, a point of time at which the diode is turned off, and the second peak value. The system control unit is further configured to update the gate control signal using the mean value. In addition, in some embodiments, the system control unit is configured to determine the point of time at which the power transistor is turned off by using the gate control signal.

Embodiments of the present invention also provide a method of controlling a static current of an LED driver, such as the LED driver described in the preceding paragraph. In such embodiments, the method includes a parameter extraction step, a pulse form output current generation step, a mean value generation step, and a gate control signal adjustment step. The parameter extraction step includes detecting a first peak value that is a highest value of the currents flowing through the power transistor, detecting a second peak value that is a highest value of the currents flowing through the diode, detecting the point of time at which the power transistor is turned off, and detecting the point of time at which the current flowing through the diode becomes 0. The pulse form output current generation step includes generating output currents of a pulse form using the second peak value, the point of time at which the power transistor is turned off, and the point of time at which the current flowing through the diode becomes 0. The mean value generation step includes generating the mean value of output currents using the output currents of a pulse form that are included in the specific time interval. The gate control signal adjustment step includes adjusting the gate control signal using the mean value.

### BRIEF DESCRIPTION OF THE DRAWINGS

The above objects, and other features and advantages of embodiments of the present invention will become more apparent after reading the following detailed description taken in conjunction with the drawings, in which:

FIG. 1 is a circuit diagram of a conventional LED driver;

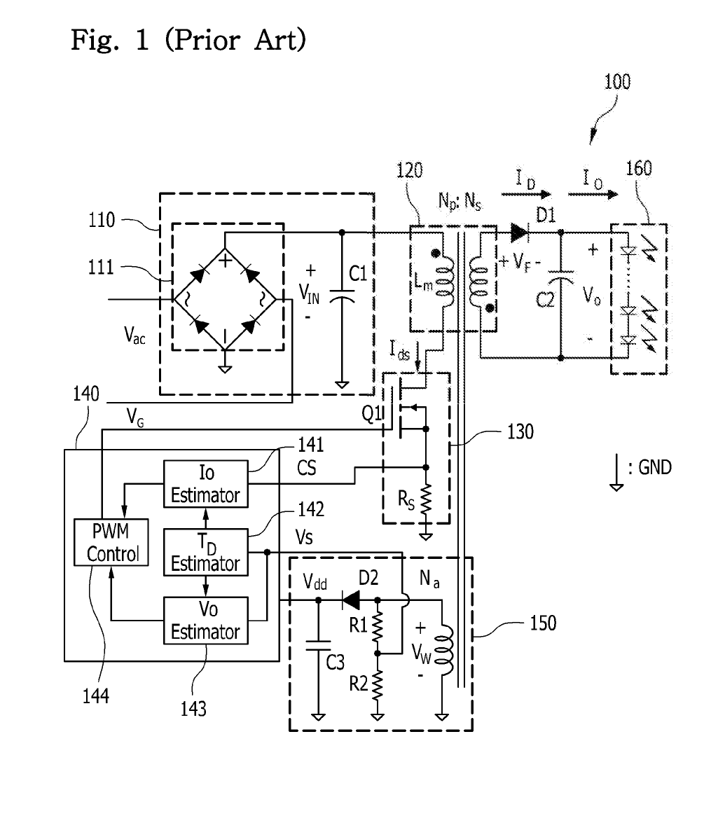

FIG. 2 shows waveforms at a specific node of the LED driver shown in FIG. 1;

FIG. 3 is a circuit diagram of an LED driver in accordance with an embodiment of the present invention;

FIG. 4 is a flowchart illustrating a method of controlling the static current of an LED driver in accordance with an embodiment of the present invention;

FIG. 5 shows electrical waveforms at a specific node of the LED driver in accordance with an embodiment of the present invention; and

FIG. 6 shows current that flows through a power transistor when an input voltage is a DC voltage having a great ripple.

### DETAILED DESCRIPTION OF EMBODIMENTS OF THE INVENTION

Reference will now be made in greater detail to embodiments of the present invention, examples of which are illustrated in the accompanying drawings. Wherever possible, the same reference numerals will be used throughout the drawings and the description to refer to the same or like parts.

A core idea of some embodiments of the present invention is to convert an electric current, supplied to an LED array connected to the secondary side of a transformer, into an electric current of a pulse form using a small number of parameters, and to generate a gate control signal for controlling the operation of a switching element on the primary side of the transformer using the mean value of a plurality of converted output currents that belong to a specific time interval.

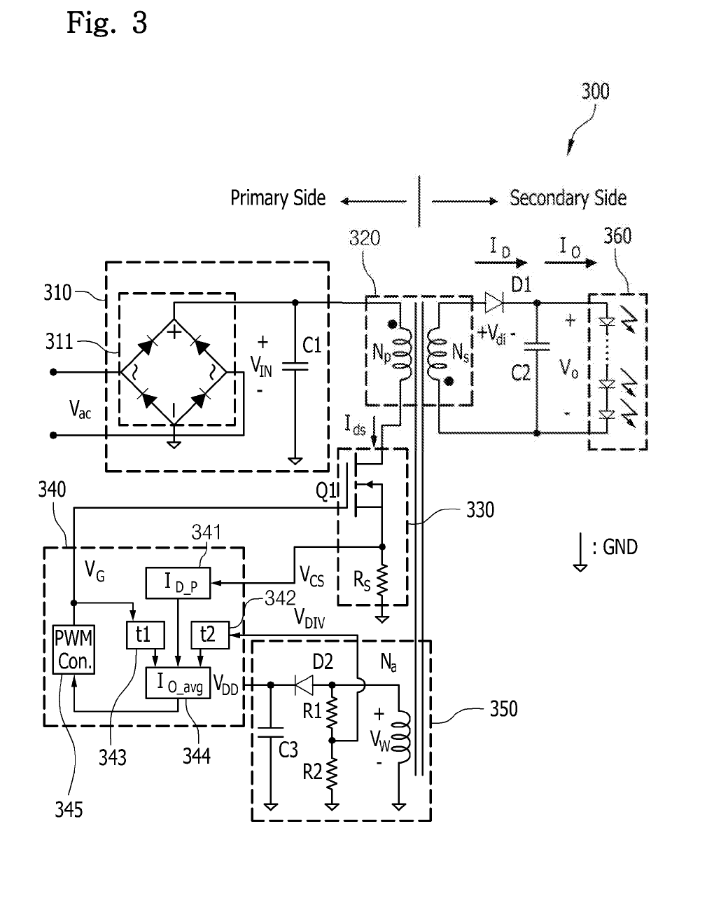

FIG. 3 is a circuit diagram of an LED driver in accordance with an embodiment of the present invention.

Referring to FIG. 3, the LED driver 300 performs a function of transferring an input voltage V_{IN}, supplied to a primary coil, to an LED array 360 connected to a circuit on the secondary side and includes a power conversion unit 310, a transformer 320, a switching unit 330, a system control unit 340, and a zero current detection unit 350 placed on the primary side.

In the present embodiment, a supply voltage supplied to the LED driver 300 is illustrated as being an AC voltage V_{ac}, but is not limited thereto. For example, the supply voltage may be a DC voltage. If the supply voltage is a DC voltage, the LED driver 300 of the present embodiment may not include the power conversion unit 310.

The power conversion unit 310 includes a rectifier 311 and a first capacitor C1 connected between the output terminal of the rectifier 311 and a ground GND. The power conversion unit 310 rectifies the AC voltage V_{ac} using the rectifier 311 and converts the rectified voltage of the first capacitor C1 into the input voltage V_{IN}. The input voltage V_{IN} becomes a DC voltage rarely having a ripple or having a very small ripple when the first capacitor C1 has a high capacitance, but may become a DC voltage having a great ripple when the first capacitor C1 has a low capacitance. The DC voltage having a great ripple includes voltage having a waveform that is substantially similar to the waveform of a rectified voltage. As will be described later, the LED driver of the present embodiment can operate effectively when the input voltage V_{IN} is not only a DC voltage that does not have a ripple or has a small ripple, but also a DC voltage having a great ripple.

The switching unit 330 includes a power transistor Q1 configured to operate in response to a gate control signal V_{G} generated from the system control unit 340 and a switching resistor Rs placed between the power transistor Q1 and the ground GND.

The transformer 320 transfers the input voltage V_{IN} to a secondary coil at a specific ratio in response to the switching operation of the switching unit 330 connected to the primary coil. Assuming that the number of turns of the primary coil included in the transformer 320 is N_{P} and the number of turns of the secondary coil included therein is N_{S}, the specific ratio refers to a turn ratio of the number of turns N_{P} of the primary coil and the number of turns N_{S} of the secondary coil.

The zero current detection unit 350 generates a division voltage V_{DIV} by dividing a resonant voltage V_{W} using two resistors R₁ and R₂. The resonant voltage V_{W} is voltage in which a ratio of the number of turns of the secondary coil N_{S} and the number of auxiliary turns Nₐ is incorporated into voltage V_{O} that drops to the LED array 360 and voltage V_{di} that drops to a diode D1 connected to the secondary coil of the transformer 320. The division voltage V_{DIV} is obtained by dividing the resonant voltage V_{W} at a ratio of the resistors R₁ and R₂. In the following description, it is assumed that the resonant voltage V_{W} and the division voltage V_{DIV} maintain the above relation although it is not specifically described.

The system control unit 340 includes a diode current peak value estimator 341, a diode turn-off time point detector 342, a power transistor turn-off time point detector 343, a mean value calculator 344, and a PWM controller 345.

The diode current peak value estimator 341 detects a first peak value I_{ds}_{_{—}}ₚ, that is, the highest value of current I_{ds} that flows through the power transistor Q1, and estimates a second peak value I_{D}_{_{—}}ₚ using the first peak value I_{ds}_{_{—}}ₚ. The second peak value I_{D}_{_{—}}ₚ is the highest value of currents that flow through the diode D1 on the secondary side and can be estimated by the product of a turn ratio of the number of turns of the primary coil N_{P} and the number of turns of the secondary coil N_{S} of the transformer 320 and the first peak value I_{ds}_{_{—}}ₚ.

The diode turn-off time point detector 342 detects a point of time t₂ at which the diode D1 connected to the secondary coil is turned off using the division voltage V_{DIV}. The division voltage V_{DIV} has a level of voltage obtained by multiplying the sum of the voltage V_{di} that drops to the diode D1 connected to the secondary coil and the voltage V_{O} that drops to the LED array 360 connected to the secondary side by a turn ratio of the number of turns of the secondary coil N_{S} and the number of auxiliary turns Nₐ at the moment when the power transistor Q1 is turned off and then shows a constant resonance characteristic at a point of time t₂ at which the diode D1 connected to the secondary coil is turned off.

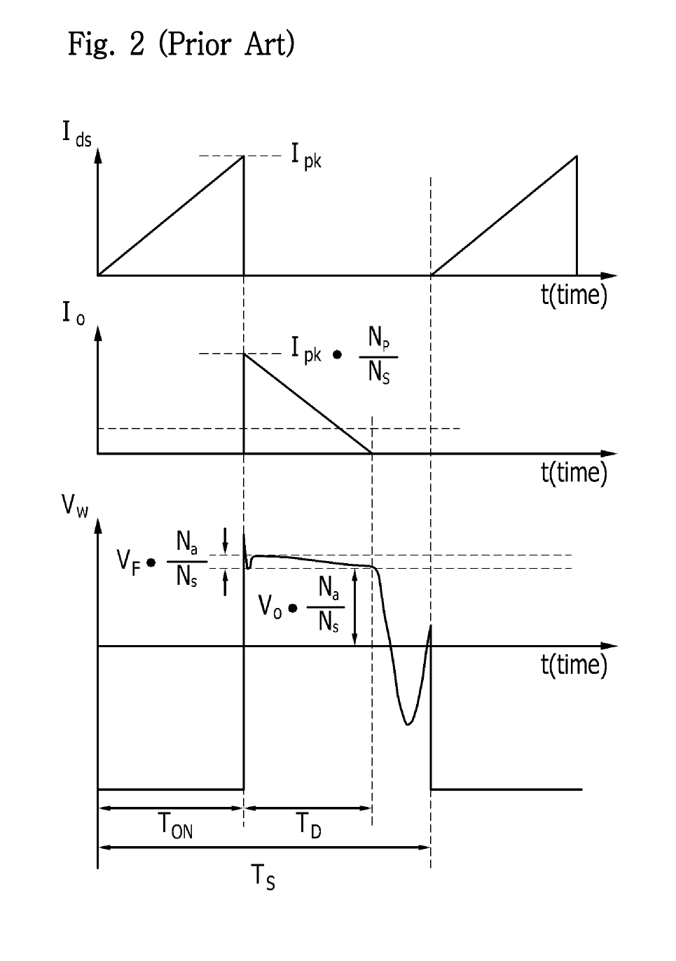

From FIG. 2, it can be seen that the voltage level of the resonant voltage V_{W} is sharply decreased at the point of time t₂ at which the diode D1 connected to the secondary coil is turned off. This part may be likewise applied to the present embodiment. Accordingly, the diode turn-off time point detector 342 can detect the point of time t₂ at which the diode D1 is turned off by detecting a point of time at which the voltage level of the resonant voltage V_{W} is sharply decreased through a differentiator, etc.

The power transistor turn-off time point detector 343 detects the point of time t₁ at which the power transistor Q1 is turned off using the gate control signal V_{G}.

The mean value calculator 344 accumulates output currents I_{O}_{_{—PWM}} of a pulse form each of which corresponds to the current I₀ supplied to the LED array 360 using the point of time t₁ at which the power transistor Q1 is turned off, the point of time t₂ at which the diode D1 connected to the secondary side is turned off, and the second peak value I_{D}_{_{—}}ₚ, and generates a mean value I_{O}_{_{—}}_{avg} by averaging output currents I_{O}_{_{—}}_{PWM} included in a specific time interval, from among the accumulated output currents I_{O}_{_{—}}_{PWM}.

The output current I_{O}_{_{—}}_{PWM} has a pulse width ranging from the point of time t₁ at which the power transistor Q1 is turned off to the point of time t₂ at which the diode D1 connected to the secondary coil is turned off. It is preferred that the amplitude of the output current I_{O}_{_{—}}_{PWM} be ½ of the second peak value I_{D}_{_{—}}ₚ. However, the amplitude of the output current I_{O}_{_{—}}_{PWM} is not limited to ½ of the second peak value I_{D}_{_{—}}ₚ, but may have a variety of multiples, such as ¼ or 2. The form of the output current I_{O}_{_{—}}_{PWM} is described later.

The mean value calculator 344 may include a low pass filter for receiving the output currents I_{O}_{_{—}}_{PWM} for a specific time interval and generating the mean value I_{O}_{_{—}}_{avg} using the received output currents I_{O}_{_{—}}_{PWM}. Here, the specific time interval can be determined by the frequency of the AC voltage V_{ac} when it is converted into the input voltage V_{IN} by the first capacitor C1.

The PWM controller 345 generates the gate control signal V_{G} using the mean value I_{O}_{_{—}}_{avg}. The current I_{ds} that flows through the power transistor Q1 can be easily estimated using voltage V_{CS} at a node to which the power transistor Q1 and the switching resistor Rs are connected and a resistance value of the switching resistor Rs without using a current meter.

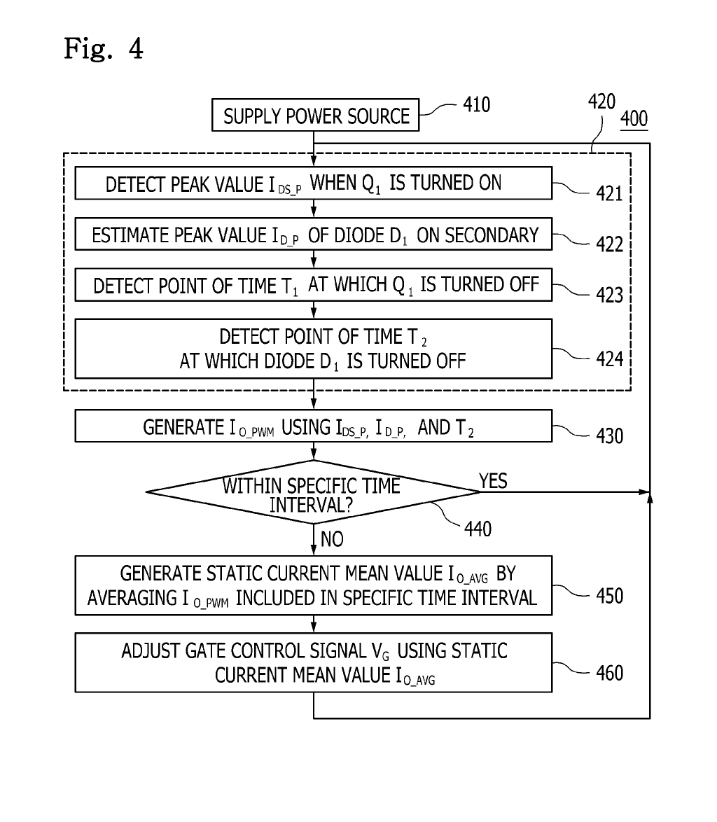

FIG. 4 is a flowchart illustrating a method of controlling the static current of an LED driver in accordance with an embodiment of the present invention.

Referring to FIG. 4, the method 400 of controlling the static current of the LED driver is applied to the LED driver 300 of FIG. 3, and it includes a power source supply step 410, a parameter extraction step 420, a pulse form output current generation step 430, a specific time interval determination step 440, a mean value generation step 450, and a gate control signal adjustment step 460.

In the power source supply step 410, a power source necessary for the operation of the LED driver 300 is supplied. In the parameter extraction step 420, the first peak value I_{ds}_{_{—}}ₚ, that is, the highest value of currents that flow through the power transistor Q1, the second peak value I_{D}_{_{—}}ₚ, that is, the highest value of currents that flow through the diode D1 connected to the secondary side of the transformer 320, the point of time t₁ at which the power transistor Q1 is turned off, and the point of time t₂ at which current flowing through the diode D1 connected to the secondary side of the transformer 320 becomes 0 are detected (421 to 424). Here, the second peak value I_{D}_{—}ₚ is determined by the product of a turn ratio of the primary winding N1 and the secondary winding N2 of the coil that forms the transformer 320 and the first peak value I_{ds}_{_{—}}ₚ.

In the pulse form output current generation step 430, the output current I_{O}_{_{—}}_{PWM} of a pulse form is generated using the second peak value I_{D}_{_{—}}ₚ, the point of time t₁ at which the power transistor Q1 is turned off, and the point of time t₂ at which the current of the diode D1 connected to the secondary side of the transformer 320 becomes 0. The output current I_{O}_{_{—}}_{PWM} of a pulse form has a pulse width ranging from the point of time t₁ at which the power transistor Q1 is turned off to the point of time t₂ at which the diode D1 connected to the secondary coil is turned off. The amplitude of the output current I_{O}_{_{—}}_{PWM} may be ½ of the second peak value I_{D}_{_{—}}ₚ.

In the specific time interval determination step 440, if the output current I_{O}_{_{—}}_{PWM} of a pulse form belongs to a specific time interval (Yes), the parameter extraction step 420 and the pulse form output current generation step 430 are performed. If the output current I_{O}_{_{—}}_{PWM} of a pulse form does not belong to a specific time interval (No), the mean value generation step 450 is performed.

In the mean value generation step 450, the mean value I_{O}_{_{—}}_{avg} is generated by averaging the output currents I_{O}_{_{—}}_{PWM} of a pulse form that belong to the specific time interval. In the gate control signal adjustment step 460, the gate control signal V_{G} is adjusted using the mean value I_{O}_{_{—}}_{avg}.

The parameter extraction step 420, the pulse form output current generation step 430, the specific time interval determination step 440, the mean value generation step 450, and the gate control signal adjustment step 460 may be repeatedly performed while the LED driver 300 supplies a static current to the LED array 360.

In the present embodiment, the amplitude of the output current I_{O}_{_{—}}_{PWM} has been illustrated as being ½ of the second peak value I_{D}_{_{—}}ₚ. If the amplitude of the output current I_{O}_{_{—}}_{PWM} is not ½ of the second peak value I_{D}_{_{—}}ₚ, such as, for example, where the multiple is instead is ¼, ⅙, or 2, then the mean value generation step 450 may further include a correction step of multiplying the mean value I_{O}_{_{—}}_{avg} by 2, 3, or ¼.

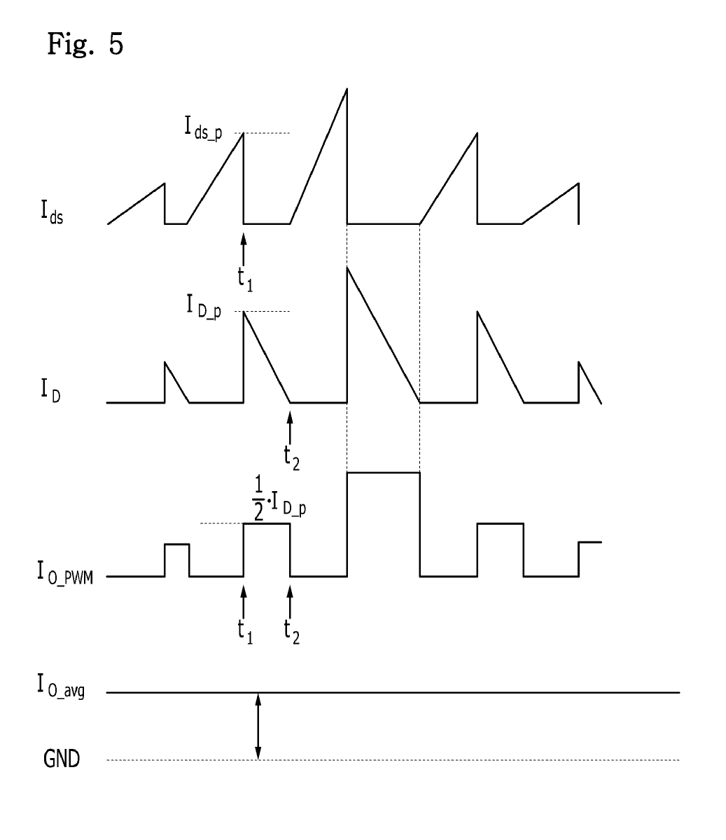

FIG. 5 shows electrical waveforms at a specific node of the LED driver in accordance with an embodiment of the present invention.

Referring to FIG. 5, the current I_{ds} flowing through the power transistor Q1 rises in an interval in which the power transistor Q1 is turned on, but does not flow in an interval in which the power transistor Q1 is turned off. This is the same as the case of FIG. 2. Here, t₁ refers to the point of time at which the power transistor Q1 is turned off. The point of time can be easily detected from the gate control signal V_{G} supplied to the power transistor Q1.

The diode D1 connected to the secondary coil is turned on at the moment when the power transistor Q1 is turned off, and thus the current I_{D} flowing through the diode D1 has the peak value I_{D}_{_{—}}ₚ of a diode current, having an amount obtained by multiplying the peak value Iₚₖ of the current I_{ds} that flows through the power transistor Q1 by the turn ratio Nₚ/N_{S} of the primary winding N1 and the secondary winding N2 of the coil that forms the transformer 320. The current I_{D} flowing through the diode D1 connected to the secondary coil slowly decreases from the peak value I_{D}_{_{—}}ₚ of the diode current and becomes a zero state when the point of time t₂ at which the diode D1 connected to the secondary coil is turned off. The point of time t₂ at which the diode D1 connected to the secondary coil is turned off can be detected using various methods, but embodiments of the present invention propose a method of simply detecting the point of time t₂ using the division voltage V_{DIV} obtained by dividing the resonant voltage V_{W} using the two resistors R₁ and R₂ as described above.

The current I_{D} that flows through the diode D1 connected to the secondary coil will be supplied to the LED array 360 connected to a circuit on the secondary side without change. As shown in FIG. 5, however, the current I_{D} is not supplied consecutively, but supplied discontinuously. Furthermore, the total energy supplied to the LED array 360 is changed instantaneously.

In an embodiment of the present invention, the currents I_{D} that flow through the diode D1 connected to the secondary coil for a specific time interval are averaged by taking the above characteristic into account, and static current supplied to the LED array 360 is controlled using the mean value.

To this end, first, current supplied to the LED array 360 is defined as the output current I_{O}_{_{—}}_{PWM} of a pulse form. In order to represent the output current I_{O}_{_{—}}_{PWM} of a pulse form, the width and size of the pulse have to be determined.

The width of the pulse becomes a time interval |t₂-t₁| in which the current I_{D} flowing through the diode D1 connected to the secondary coil is activated.

Referring to FIG. 5, the current I_{D} flowing through the diode D1 is slowly decreased with the peak value I_{D}_{_{—}}ₚ of the diode current from the point of time t₁ at which the time interval |t₂-t₁| is started over time, and it has a zero value at the point of time t₂ at which the time interval |t₂-t₁| is ended. An actual waveform may be different from a triangular waveform shown in FIG. 5. In this case, the actual waveform may be close to a triangular waveform. Accordingly, the size of the pulse becomes half the peak value I_{D}_{_{—}}ₚ of the diode current.

The mean value I_{O}_{_{—}}_{avg} can be obtained by averaging a plurality of the pulses of the output currents I_{O}_{_{—}}_{PWM} included in a specific time interval as described above.

As described above, in embodiments of the present invention, one cycle T_{S} of a previous gate control signal V_{G} and an interval T_{D} in which the diode D1 on the secondary side is turned on are not necessary in order to generate the gate control signal V_{G}, and the point of time t₁ at which the power transistor Q1 is turned off and the point of time t₂ at which the diode D1 connected to the secondary coil is turned off can be simply calculated. Furthermore, since the peak value Iₚₖ of the current I_{ds} that flows through the power transistor Q1 can be calculated using a conventional method, hardware is simpler than that of a conventional LED driver. Furthermore, since the static current control method of operating the LED driver is simple, the gate control signal V_{G} can be generated with a low computational load for a short time.

Some embodiments of the present invention can effectively operate both when the input voltage V_{IN} is a DC voltage having a substantially constant value and when the input voltage V_{IN} is a DC voltage having a great ripple, and a reason thereof is described below.

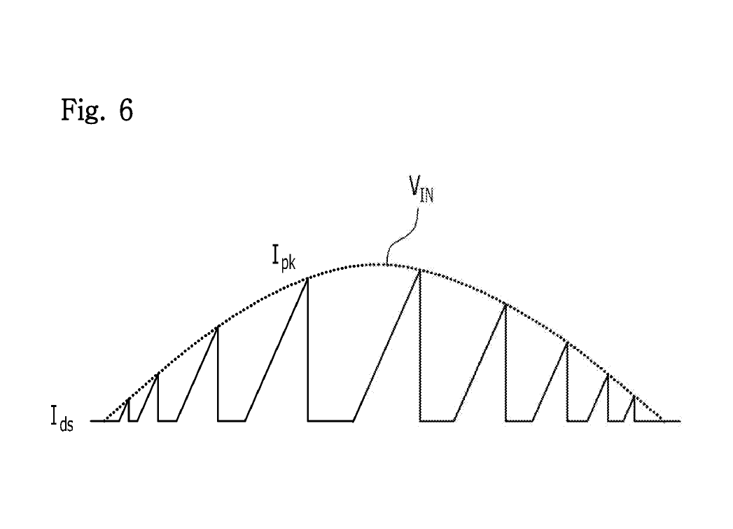

FIG. 6 shows current that flows through the power transistor when the input voltage V_{IN} is a DC voltage having a great ripple.

Referring to FIG. 6, the current I_{ds} flowing through the power transistor Q1 has a saw-toothed form. The input voltage V_{IN} having a waveform of a rectified voltage form is obtained by coupling the highest points of the saw-toothed form.

If the input voltage V_{IN} is a DC voltage having a great ripple, voltage having a waveform of a rectified voltage form is applied to the transformer 320. In general, the AC current V_{ac} supplied to the LED driver has a frequency 50-60 Hz. The gate control signal V_{G} for controlling the operation of the power transistor Q1 has a frequency of several tens of KHz, and thus the current I_{ds} flowing through the power transistor Q1 has a form, such as that shown in FIG. 6.

In this case, current flowing through the secondary side becomes the product of the peak value Iₚₖ and a ratio of the number of turns of the primary coil and the number of turns of the secondary coil of the transformer 320. Accordingly, a power factor has to be corrected because current on the secondary side has the same form as current on the primary side. In the prior art, a complicated operation for correcting the power factor must be performed every switching cycle because the turn-on and turn-off cycle of the power transistor Q1 is varied.

In accordance with an embodiment of the present invention, this power factor correction is not necessary because the mean value of currents supplied to the LED array 360 is calculated.

In the LED driver and the method of controlling the static current of the LED driver in accordance with embodiments of the present invention, a static current is controlled using the mean value of output currents obtained using a small number of parameters. Accordingly, the hardware necessary for operation is simple because the operation itself is not complicated.

Furthermore, if an input current does not have a DC form, but an AC form, a static current on the secondary side can be effectively controlled. In this case, a power factor can be improved as compared with a case where the input current has a DC form.

Although some embodiments of the present invention have been described for illustrative purposes, those skilled in the art will appreciate that various modifications, additions, and substitutions are possible without departing from the scope and the spirit of the invention as disclosed in the accompanying claims.

What is claimed is:

1. A system control unit included in a light-emitting diode (LED) driver, the LED driver also comprising a switching unit, a transformer, and a zero current detection unit, wherein the switching unit comprises a power transistor configured to operate in response to a gate control signal, and a switching resistor placed between the power transistor and a ground voltage, wherein the transformer is configured to transfer an input voltage to a secondary coil of the transformer at a specific ratio in response to a switching operation of the switching unit connected to a primary coil of the transformer, and wherein the zero current detection unit is placed on a primary side of the transformer and is configured to generate a resonant voltage into which voltage that drops to an LED array connected to the secondary coil and voltage that drops to a diode connected to the secondary coil are incorporated,
wherein the system control unit is configured to:
estimate a second peak value that is a highest value of currents flowing through the diode using current flowing through the power transistor;
calculate a mean value of currents supplied to the LED array for a specific time interval using a point of time at which the power transistor is turned off, a point of time at which the diode is turned off, and the second peak value; and
update the gate control signal using the mean value,
wherein the system control unit is configured to determine the point of time at which the power transistor is turned off by using the gate control signal.

2. The system control unit of claim 1, wherein the system control unit comprises:
a diode current peak value estimator configured to detect a first peak value that is a highest value of the currents flowing through the power transistor and estimate the second peak value using the first peak value;
a diode turn-off time point detector configured to detect the point of time at which the diode is turned off using the resonant voltage;
a power transistor turn-off time point detector configured to detect the point of time at which the power transistor is turned off using the gate control signal;
a mean value calculator configured to generate the mean value of output currents of a pulse form corresponding to the currents supplied to the LED array for the specific time interval, using the point of time at which the power transistor is turned off, the point of time at which the diode is turned off, and the second peak value; and
a pulse width modulation (PWM) controller configured to update the gate control signal using the mean value.

3. The system control unit of claim 2, wherein:
the diode current peak value estimator is configured to estimate the second peak value using a product of a ratio of a number of turns of the primary coil and a number of turns of the secondary coil that form the transformer and the first peak value; and
the specific ratio is the ratio of the number of turns of the primary coil and the number of turns of the secondary coil that form the transformer.

4. The system control unit of claim 2, wherein:
the output currents of a pulse form have a pulse width ranging from the point of time at which the power transistor is turned off to the point of time at which the diode is turned off; and
a size of the pulse is half the second peak value.

5. The system control unit of claim 2, wherein the mean value calculator comprises a low pass filter configured to receive the output currents of a pulse form for the specific time interval and to generate the mean value using the output currents.

6. The system control unit of claim 1, wherein the current flowing through the power transistor is estimated using voltage that drops between the power transistor and the switching resistor and a resistance value of the switching resistor.

7. An LED driver, comprising:
a power conversion unit configured to generate an input voltage by rectifying a supply voltage of an AC form;
a switching unit comprising a power transistor configured to operate in response to a gate control signal, and a switching resistor placed between the power transistor and a ground voltage;
a transformer configured to transfer the input voltage or a supply voltage of a DC form to a secondary coil of the transformer at a specific ratio in response to a switching operation of the switching unit connected to a primary coil of the transformer;
a zero current detection unit placed on a primary side of the transformer and configured to generate a resonant voltage into which voltage that drops to an LED array connected to the secondary coil and voltage that drops to a diode connected to the secondary coil are incorporated; and
a system control unit configured to:
estimate a second peak value that is a highest value of currents flowing through the diode using current flowing through the power transistor;
calculate a mean value of currents supplied to the LED array for a specific time interval using a point of time at which the power transistor is turned off, a point of time at which the diode is turned off, and the second peak value; and
update the gate control signal using the mean value,
wherein the system control unit is configured to determine the point of time at which the power transistor is turned off by using the gate control signal.

8. The LED driver of claim 7, wherein the system control unit comprises:
a diode current peak value estimator configured to detect a first peak value that is a highest value of the currents flowing through the power transistor and estimate the second peak value using the first peak value;
a diode turn-off time point detector configured to detect the point of time at which the diode is turned off using the resonant voltage;
a power transistor turn-off time point detector configured to detect the point of time at which the power transistor is turned off using the gate control signal;
a mean value calculator configured to generate the mean value of output currents of a pulse form corresponding to the currents supplied to the LED array for the specific time interval, using the point of time at which the power transistor is turned off, the point of time at which the diode is turned off, and the second peak value; and
a PWM controller configured to update the gate control signal using the mean value.

9. The LED driver of claim 8, wherein:
the diode current peak value estimator is configured to estimate the second peak value using a product of a ratio of a number of turns of the primary coil and a number of turns of the secondary coil that form the transformer and the first peak value; and
the specific ratio is the ratio of the number of turns of the primary coil and the number of turns of the secondary coil that form the transformer.

10. The LED driver of claim 8, wherein:
the output currents of a pulse form have a pulse width ranging from the point of time at which the power transistor is turned off to the point of time at which the diode is turned off; and
a size of the pulse is half the second peak value.

11. The LED driver of claim 8, wherein the mean value calculator comprises a low pass filter configured to receive the output currents of a pulse form for the specific time interval and to generate the mean value using the output currents.

12. The LED driver of claim 7, wherein the specific time interval is determined by a frequency of the AC voltage.

13. The LED driver of claim 7, wherein the current flowing through the power transistor is estimated using voltage that drops between the power transistor and the switching resistor and a resistance value of the switching resistor.

14. A method of controlling a static current of an LED driver according to claim 7, the method comprising:
a parameter extraction step of detecting a first peak value that is a highest value of the currents flowing through the power transistor, detecting the second peak value that is a highest value of the currents flowing through the diode, detecting the point of time at which the power transistor is turned off, and detecting the point of time at which the current flowing through the diode becomes 0;
a pulse form output current generation step of generating output currents of a pulse form using the second peak value, the point of time at which the power transistor is turned off, and the point of time at which the current flowing through the diode becomes 0;
a mean value generation step of generating the mean value of output currents included in the specific time interval; and
a gate control signal adjustment step of adjusting the gate control signal using the mean value.

15. The method of claim 14, wherein the second peak value that is the highest value of the currents flowing through the diode is determined by a product of a ratio of a number of turns of the primary coil and a number of turns of the secondary coil that form the transformer and the first peak value.

16. The method of claim 15, wherein:
the output currents of a pulse form have a pulse width ranging from the point of time at which the power transistor is turned off to the point of time at which the diode is turned off; and
a size of the pulse is half the second peak value.

17. The method of claim 15, wherein the specific time interval is determined by a frequency of an AC voltage.

18. The method of claim 14, further comprising a specific time interval determination step of performing the parameter extraction step and the pulse form output current generation step if the output current of a pulse form is included in the specific time interval, and performing the mean value generation step if the output current of a pulse form is not included in the specific time interval.

19. The method of claim 18, wherein the parameter extraction step, the pulse form output current generation step, the specific time interval determination step, the mean value generation step, and the gate control signal adjustment step are repeatedly performed while the LED driver supplies a static current to the LED array.

20. The method of claim 14, wherein the current flowing through the power transistor is estimated using voltage that drops between the power transistor and the switching resistor and a resistance value of the switching resistor.
